(19) United States
(12) Patent Application Publication
(10) Pub. No.: US 2014/0180774 A1
(43) Pub. Date: Jun. 26, 2014

(54) SYSTEMS AND METHODS FOR MANAGING PARKING TRANSACTIONS

(71) Applicants: Anand P. RANGARAJAN, Hillsboro, OR (US); Vijay Sarathi KESAVAN, Hillsboro, OR (US); Somya RATHI, Portland, OR (US)

(72) Inventors: Anand P. RANGARAJAN, Hillsboro, OR (US); Vijay Sarathi KESAVAN, Hillsboro, OR (US); Somya RATHI, Portland, OR (US)

(21) Appl. No.: 13/726,849

(22) Filed: Dec. 26, 2012

(51) Int. Cl. G06Q 30/02

(52) U.S. Cl. CPC G06Q 30/0284
USPC 705/13

(57) ABSTRACT

Certain embodiments herein are directed to managing parking-related transactions. Such transactions may include, but are not limited to, extending an amount of time purchased for parking a vehicle in a parking space and transferring an amount of parking time between parking spaces. An authentication code may be generated in association with an initial purchase of parking time and subsequently used to facilitate parking time extensions or transfers. A parking transaction server may receive and validate requests for parking transactions, as well as send a response to a parking transaction terminal associated with a request for a parking transaction. Certain embodiments herein also relate to the parking transaction server receiving indications that vehicles have entered or exited a parking space, and based on such indications, may manage an amount of parking time remaining to optimize the amount or parking time available for parking a vehicle in a parking space.

### TECHNICAL FIELD

Embodiments of this disclosure relate generally to computer networks that facilitate vehicular parking, and more particularly, to managing transactions associated with vehicular parking

### BACKGROUND

Vehicle owners may park vehicles in a parking space for a specified duration of time. An owner may indicate such time upon parking a vehicle in a parking space. After the time has expired, an owner may be subject to penalties and/or fines if the owner's vehicle remains parked in a parking space beyond the allocated time. To avoid penalties or fines, an owner may be required to act before such expiration. Existing solutions for purchasing additional time may be cumbersome in the way that they may require an owner to return to a location at or near the vehicle to purchase additional time for parking. Further, existing systems may not enable owners to transfer unused parking time to successive parking spaces, which may result in waste to owners who overestimate the amount of time a vehicle will be parked in a parking space. Such a deficiency may exist because existing systems may not provide a mechanism for pausing an amount of parking time remaining when a vehicle exits a parking space. Existing systems may also restrict users to certain devices, such as a device used to purchase parking time, to complete parking transactions.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example computing system for managing parking transactions, according to an embodiment of the disclosure.

FIG. 2 illustrates a block diagram of an example computing system for managing vehicular parking time, according to an embodiment of the disclosure.

FIG. 3A illustrates a schematic diagram of an example parking transaction for which an authentication code may be generated, according to an embodiment of the disclosure.

FIG. 3B illustrates a database for storing parking transaction data, according to an embodiment of the disclosure.

FIG. 4 illustrates a schematic diagram of an example system for extending vehicular parking time via a user device, according to an embodiment of the disclosure.

FIG. 5 illustrates a schematic diagram of an example system for transferring vehicular parking time between parking spaces, according to an embodiment of the disclosure.

FIG. 6 illustrates a flow diagram of an example process for storing parking transaction information associated with purchasing parking time, according to an embodiment of the disclosure.

FIG. 7 illustrates a flow diagram of an example process for extending parking time associated with parking a vehicle in a parking space, according to an embodiment of the disclosure.

FIG. 8 illustrates a flow diagram of an example process for transferring parking time between parking spaces, according to an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein relate to, among other things, managing transactions associated with parking a vehicle in a parking space. A user, such as a driver of a vehicle, may park a vehicle in a parking space and purchase time that authorizes the vehicle to remain in the parking space for an amount of time commensurate with the purchase. An authentication code may be generated and associated with details of each parking transaction, such as an identifier of the parking space in which the vehicle was parked, the time of expiry for parking the vehicle in the parking space, the parking state associated with the parking space (e.g., vacant or occupied), etc. Such an authentication code may be utilized to perform various functions associated with the management of vehicular parking transactions, such as extending the duration for parking a vehicle in a parking space and transferring parking time between parking spaces.

A user may utilize a computing device, such as a smart phone or laptop computer, to extend the duration for which a vehicle is authorized to park in a parking space. For example, a user may specify an authentication code at the user device to receive parking transaction details associated with the authentication code, such as the parking space identifier and time of expiry. Based on the received parking transaction details, the user may specify an additional amount of time by which to extend the parking duration. In this way, a user may extend parking time duration without returning to the location at which the parking time may have been purchased, which may include a parking transaction terminal for facilitating such a purchase, according to certain embodiments herein.

An authentication code generated herein may also be used to transfer parking time between parking spaces. Transferring parking time may refer to the process of using parking time associated with an authentication code for parking a vehicle in multiple parking spaces, for example, parking spaces subsequent to the parking space for which the parking time was initially purchased. According to one configuration, a sensor device may detect when a vehicle has exited a parking space and, subsequent to the vehicle's exit, may provide an indication of such exit to a device that may respond by causing a parking time expiry associated with the authentication code to pause or halt for the exited parking space. Thus, parking time duration may be preserved while a vehicle is not parked in a parking space. A user may use the preserved parking time upon specifying the authentication code along with a different parking space, for example, to which the vehicle may have been driven to for parking. Upon a user specifying a new parking space for the authentication code, certain embodiments herein may resume decrementing the parking time duration associated with the authentication code.

In addition to the technical effects described above, additional technical effects may include, but are not limited to, the capability of managing parking transactions from multiple devices. For example, a device other than a device used to purchase parking time may be utilized to extend parking time. In this way, a parking transaction may not be tied to a particular device.

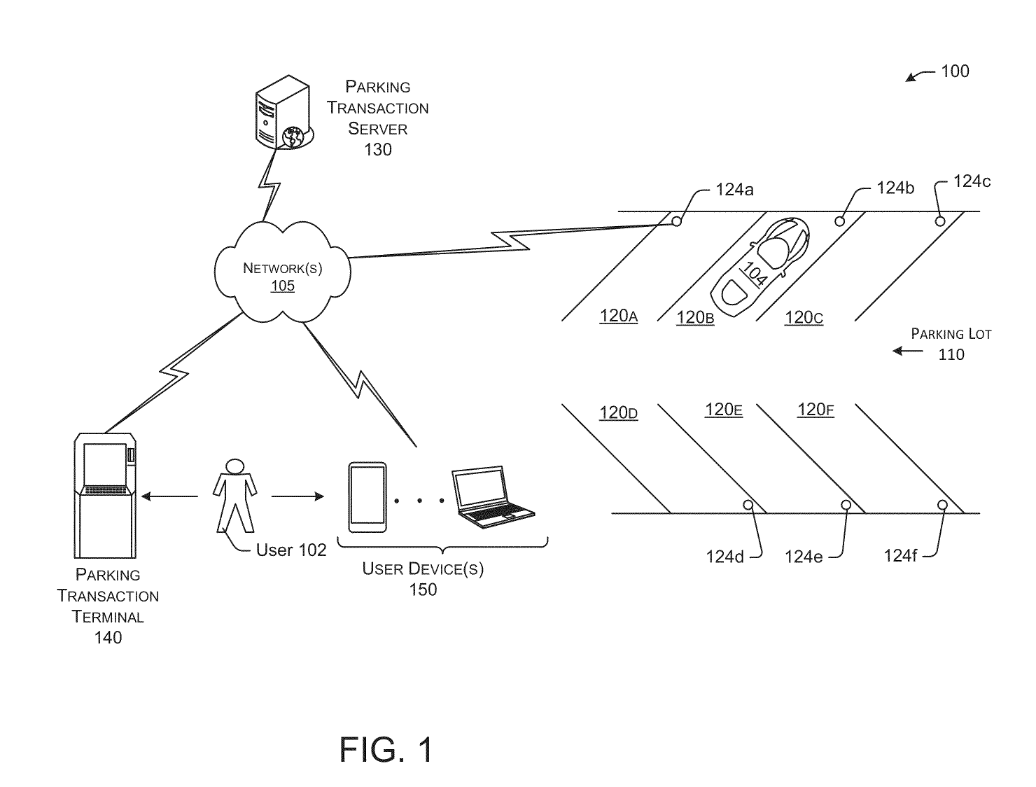

FIG. 1 depicts an example computing system for managing parking transactions, according to an embodiment of the disclosure. As shown in FIG. 1, a vehicle 104 may be parked in a parking lot 110 that includes multiple parking spaces 120a-f. A user 102 may park the vehicle 104 in a parking space, such as parking space 120B. While an automobile 104 is shown, other vehicles may include motorcycles, scooters, other motor vehicles, or other machines for transporting users to and from parking spaces.

A parking transaction terminal 140 may refer to a device that facilitates a user's purchase of parking time associated with parking a vehicle in a parking space. The parking transaction terminal 140 may include a keyboard, voice recognition software, bar code readers or scanners, touch screen input, or other input mechanisms that may enable the parking transaction terminal 140 to receive input from a user and/or various other devices. The parking transaction terminal 140 may also include a printer or other device for printing text, graphics, etc., onto paper or other materials. As described in greater detail below, the parking transaction terminal 140 may include one or more user interfaces to guide a user's purchase of parking time, as well as other management functions described herein. In one embodiment, the parking transaction terminal 140 may facilitate communications between a user 102 and a parking transaction server 130 to enable the management of parking transactions, such as purchasing parking time, extending parking time, or transferring parking time.

The parking transaction terminal 140 may be located at or near the parking lot 110 (as shown in FIG. 1), where it may be accessed by a user 102 who has parked a vehicle 104 in the parking lot 110, in one example. In some embodiments, a parking transaction terminal 140 may be located at each parking space such that a user may interface with a dedicated device for parking a vehicle in a parking space.

The parking transaction terminal 140 may further receive input from one or more sensors 124a-f, which may detect vehicular motions, such as the entry and exit of vehicles into a parking space, and may send an indication of such motions to the parking transaction terminal 140, according to one configuration. In one embodiment, the sensors 124a-f may each be positioned respective to a parking space such that each sensor 124a-f may detect movement into and out of a particular parking space. A non-limiting example of a sensor that may be used in certain embodiments herein may include an occupancy sensor, which may detect the presence or absence of objects, such as vehicles, in a parking space. Such sensors may use various technologies to detect such presence or absence including, but not limited to, passive infrared detection, ultrasonic detection, line of sight detection, and acoustic detection. The sensors 124a-f may be positioned in various ways, such as above ground or below ground (e.g., underneath the surface of a parking space), as non-limiting examples. In embodiments in which a parking transaction terminal 140 is positioned in each parking space 120a-f, a sensor device may be integrated into a parking transaction terminal 140 to detect movements into and out of respective parking spaces.

The user 102 may utilize any of the user devices 150 to extend parking time for a vehicle 104. As will be described in greater detail below, such devices may include a web browser or dedicated application that may enable the user 102 to interact with content such as requests for information that may be required to enable the user 102 to provide information that may be required to facilitate the management of parking transactions.

The parking transaction server 130 may be configured to communicate with the parking transaction terminal 140 and the user devices 150. The parking transaction server may be a device as described below, which may include software and/or program modules to facilitate the purchase, extension, and transfer of parking time as described herein, among other functions. In one embodiment, the parking transaction server 130 may be located at a facility managed by a parking authority or an entity that manages or controls vehicular parking spaces in a district, municipality, region, or other area or location.

According to embodiments herein, the parking transaction server 130, as well as the parking transaction terminal 140 and the user device 150, may include a radio receiver (not shown). A physical layer interface in the radio receiver may include a radio frequency (RF) unit that may be configured to provide for reception of one or more RF signals, such as those that may be sent from the sensors 124a-f or from other devices via the one or more networks 105. According to one configuration, the RF unit may include an amplifier, a mixer, a local oscillator, and so forth. The RF unit may be implemented as discrete electronic components, integrated circuits, software-defined radio, or a combination thereof, according to various configurations. The user device 150 may further include a radio transmitter that may send one or more RF signals to the other devices shown in FIG. 1, as an example. In some configurations, the parking transaction server 130, the parking transaction terminal 140, and/or the user device 150 may also include a radio transceiver that may receive and send RF signals. The transceiver (or the receiver and/or the transmitter) may be coupled to one or more antennas (not shown), which may be associated with the devices shown in FIG. 1.

As used herein, the term “device” may refer to any computing component that includes one or more processors that can be configured to execute computer-readable, computer-implemented, or computer-executable instructions. Example devices can include personal computers, server computers, server farms, digital assistants, smart phones, personal digital assistants, digital tablets, Internet appliances, application-specific circuits, microcontrollers, minicomputers, transceivers, or customer premise equipment such as set-top boxes, kiosks, or other processor-based devices. The execution of suitable computer-implemented instructions by one or more processors associated with various devices may form special purpose computers or other particular machines that may implement or facilitate collaborative bidding as described herein.

The one or more networks 105 may facilitate communication between the devices shown in FIG. 1. The one or more networks 105 may include any number of wired or wireless networks that can enable various computing devices in the example computing system 100 to communicate with one another. In some embodiments, other networks, intranets, or combinations of different types of networks may be used including, but not limited to, the Internet, intranets, cable networks, cellular networks, landline-based networks, radio networks, satellite networks, wireless fidelity (WiFi) networks, WiFi Direct networks, Bluetooth® networks, or other communication mediums connecting multiple computing devices to one another. Other embodiments may not involve a network and may, for example, provide features on a single device or on devices that are directly connected to one another, e.g., the sensors 124a-f may be directly connected to the parking transaction terminal 140.

The above configurations described in FIG. 1 are non-limiting. Different configurations, devices, numbers of parking spaces, vehicles, etc., may exist in other embodiments.

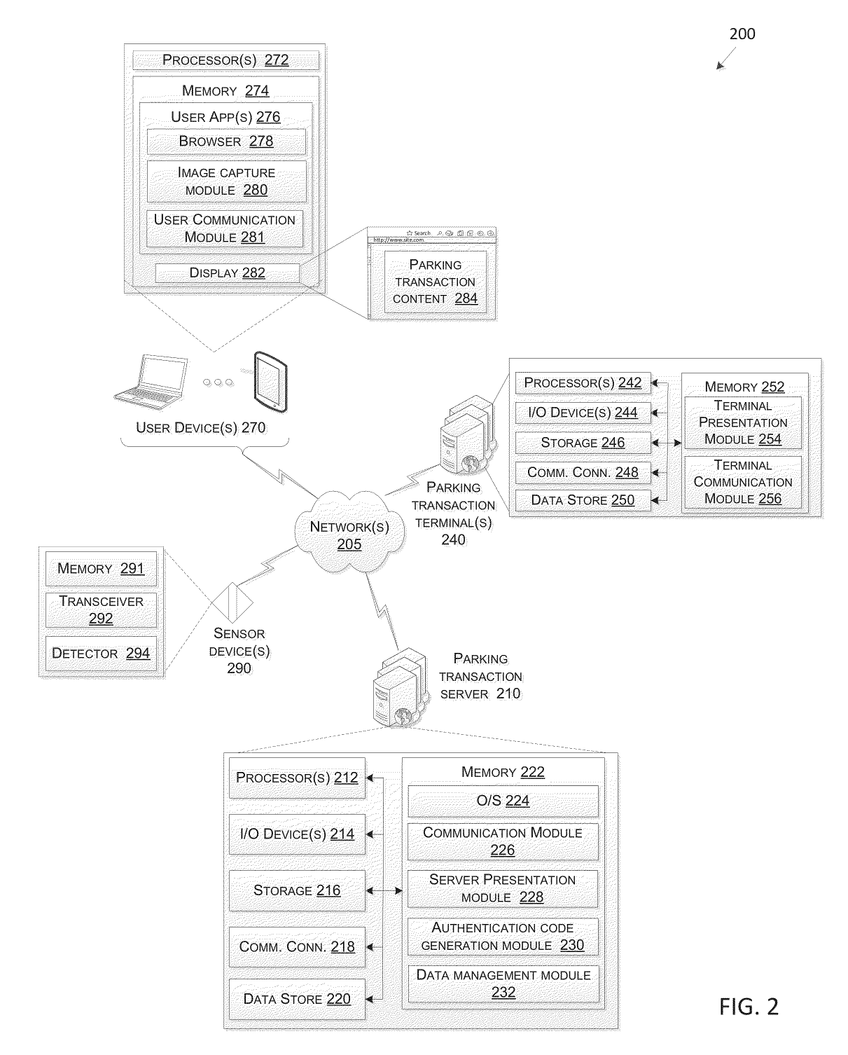

FIG. 2 depicts an example computing system 200 for managing vehicular parking time, according to an embodiment of the disclosure. The computing system 200 may include, but is not limited to, a parking transaction server 210, a parking transaction terminal 240, a user device 270, and a sensor device 290. Although only one or each of these devices is shown, more may exist in other embodiments. Each of these devices in FIG. 2 may communicate with one another over one or more networks 205. For example, the parking transaction server 210 may communicate with a parking transaction terminal 240 and/or the user device 270 to send authentication codes and various other parking transaction details, some of which will be discussed below. The parking transaction server 210 may also communicate with the parking transaction terminal 240 and/or the sensor device 290 to receive an indication of whether a parking space is vacant or occupied, as will be described in greater detail below. Various other types of communication over the one or more networks 205 may exist in other embodiments, at least some of which are described below. The one or more networks 205 may embody the one or more networks 105 in FIG. 1.

The devices in FIG. 2 may include one or more processors configured to communicate with one or more memory devices and various other components or devices. For example, the parking transaction server 210 may include one or more processors 212, one or more input/output (I/O) devices 214, storage 216, one or more communication connections 218, and one or more data stores 220. The processor 212 may be implemented as appropriate in hardware, software, firmware, or a combination thereof. The processors 242 and 272 associated with the parking transaction terminal 240 and the user device 270, respectively, may be the same or at least similar to the processor 212, in one embodiment.

The memory 222 may store program instructions that are loadable and executable on the processor 212, as well as data generated during the execution of these programs. Depending on the configuration and type of parking transaction server 210, the memory 222 may be volatile, such as random access memory (RAM), and/or non-volatile, such as read-only memory (ROM), flash memory, etc. The memory 252 and 274 associated with the parking transaction terminal 240 and the user device 270, respectively, may be the same or at least similar to the memory 222, in one embodiment.

The storage 216 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The storage 246 associated with the parking transaction terminal 240 may be the same or at least similar to the storage device 216, in one embodiment. In some implementations, the memory 222 may include multiple different types of memory, such as static random access memory (SRAM), dynamic random access memory (DRAM), or ROM.

The memory 222 and the storage 216, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The one or more communication connections 218 may allow the parking transaction server 210 to communicate with other devices, such as the parking transaction terminal 240, the user devices 270, databases, and various other devices that may exist on the one or more networks 205. In one embodiment, the communication connections 248 associated with the parking transaction terminal 240 may be the same or at least similar to the communication connections 218.

The I/O devices 214 may enable a user to interact with the parking transaction server 210 to, for example, install and configure one or more databases or other storage mechanisms to store parking transaction data. The I/O devices 214 may include, but are not limited to, a keyboard, a mouse, a pen, a voice input device, a touch input device, a display, a camera or an imaging device, speakers, or a printer. The I/O devices 244 associated with the parking transaction terminal 240 may be the same or at least similar to the I/O devices 214, in one embodiment.

The one or more data stores 220 may store lists, arrays, databases, flat files, etc. In some implementations, the data stores 220 may be stored in memory external to the parking transaction server 210 but may be accessible via the one or more networks 205, such as with a cloud storage service. The data stores 220 may store information that may facilitate management of parking transactions as described herein. Such information may include, but is not limited to, parking space identifiers, a status of a parking space (e.g., occupied or unoccupied by a vehicle), an indication of whether payment has been received for a parking space, an amount of time remaining for parking in a parking space (or parking time expiry), an authentication code that may control a user's access to parking time associated with a parking space, the date and time of purchase of parking time associated with a parking space, and other information that may facilitate management of parking transactions. In one embodiment, the data stores 250 associated with the parking transaction terminal 240 may be similar to the data stores 220.

The memory 222 may also store an operating system (O/S) 224 and various software applications and/or modules that may implement or facilitate the processes described herein. Example modules may include, but are not limited to, a communication module 226, a server presentation module 228, an authentication code generation module 230, and a data management module 232. Each of these modules may be implemented as individual modules that provide specific functionality associated with parking transaction management. Alternatively, one or more of the modules may perform all or at least some of the functionality associated with the other modules.

The communication module 226 may facilitate communication with other devices, such as the devices shown in FIG. 2. The communication module 226 may utilize various protocols to enable communication with other devices. Examples of such protocols may include, but are not limited to, Hypertext Transfer Protocol (HTTP), Transmission Control Protocol/Internet Protocol (TCP/IP), socket-based protocols such as the WebSocket protocol, Short Message Service (SMS) text messaging for supporting communication with a mobile device, Simple Mail Transfer Protocol (SMTP) for transmitting messages via electronic mail, or other message formats and/or rules for exchanging information between computing devices to support communication between web-based program code and client-server-based program code, as non-limiting examples. In one embodiment, the communication module 226 may include one or more application programming interfaces (APIs) that may utilize such protocols to facilitate communication between the parking transaction server 210 and the devices shown in FIG. 2.

According to one example, the communication module 226 may utilize HTTP and SMS text messaging to send information to a mobile device, such as a user device 270, and use the TCP/IP protocol to communicate with the parking transaction terminal 240. According to this example, the parking transaction terminal 240 may include an Internet Protocol (IP) address that enables the parking transaction terminal 240 to communicate with other devices via an IP network, such as the one or more networks 205, in one embodiment.

Messages, such as those including text or other formatted messages received and sent by the communication module 226, may be formatted in a manner that allows the communication module 226 to parse or extract information from the messages. Examples of suitable formats may include, but are not limited to, extensible markup language (XML) format, CSV format, or other text formats that may include one or more delimiters that may facilitate extraction of information from the messages. The communication module 226 may also construct messages for distribution to other devices using one or more of these formats such that a device receiving the message and configured to identify the format used to construct the message may also extract information from the message.

According to one example, the communication module 226 may construct a response message to a request to perform a parking transaction received from the parking transaction terminal 240 and/or the user device 270. The response message may include a status (e.g., approval or denial of the requested parking transaction), an authentication code associated with the requested transaction, an amount of parking time remaining associated with the requested transaction (e.g., an increased amount associated with a successful extension of parking time remaining or an amount of parking time remaining for parking a vehicle in a parking space to which the vehicle was transferred), etc.

The server presentation module 228 may generate various user interfaces that enable a user to interact with the parking transaction server 210. Such user interfaces may guide a user through a process of providing certain information that may facilitate the management of parking time as described herein. In one example, the server presentation module 228 may generate HTML or other web-based program code that may be downloaded to user device 270, e.g., via the communication module 226, to enable a user to perform parking transaction management functions, such as purchasing parking time, extending parking time, and transferring parking time. Parking transactions may be managed on a user device via a dedicated user application 276 or a web browser 278, as non-limiting examples.

In another example, the server presentation module 228 may generate one or more user interfaces for presentation at the parking transaction terminal 240. Such user interfaces may facilitate the purchase, extension, and transfer of parking time between parking spaces, among other functions, as will be described in greater detail below. In one embodiment, at least a portion of the presentation of the user interfaces may be provided by the server presentation module 228, and at least one other portion of the presentation of the user interfaces may be performed by the terminal presentation module 254. In one aspect of the embodiment, the terminal presentation module 254 may format user interface information or other content received from the server presentation module 228.

The authentication code generation module 230 may generate an authentication code for a parking transaction, such as the purchase of parking time for parking a vehicle in a parking space. An authentication code may include various characteristics. For example, an authentication code may be a unique identifier that uniquely identifies each parking transaction. The authentication code may be randomly generated using various techniques to ensure its uniqueness. The generated authentication code may be a unique text string, number, alphanumeric string, etc. Upon specifying a particular authentication code, for example, a user may access and/or update parking transaction details (e.g., purchase, time extension, or transfer information) associated with the authentication code at the time of generation of the authentication code, in one embodiment. As another example, an authentication code may expire after a certain amount of time, which may be a default amount of time specified by the authentication code generation module 230. After such time has been reached, the authentication code may no longer be valid for managing parking transactions.

The data management module 232 may manage parking transaction data. Such management may include, but is not limited to, inserting, updating, or more generally storing parking transaction information, as well as retrieving parking transaction information. In one configuration, the data management module 232 may store parking transaction information in a database, or a collection of data items stored in an organized fashion for accessing and updating data. The authentication code may be a primary key or may uniquely identify each record in the database in such a configuration. Examples of information that may be included in a database herein, including updates to such information, are described below. In other embodiments, techniques other than databases may be utilized to store parking transaction information. Such techniques or mechanisms may include files, lists, arrays, or other collections of information that may be configured to associate information or data with particular transactions.

The parking transaction terminal 240 may include one or more software or program modules that may facilitate the processes described herein. In one implementation, the parking transaction terminal 240 may embody the parking transaction terminal 140 in FIG. 1. As described, the parking transaction terminal 240 may include a terminal presentation module 254 that may guide or prompt users for information that may be utilized to manage parking transactions. Examples of such user interfaces will be described in detail below.

The terminal communication module 256 may configure the parking transaction terminal 240 to communicate with various devices in FIG. 2, such as the parking transaction server 210, the user devices 270, and the sensor devices 290. For example, the terminal communication module 256 may communicate with the parking transaction server 210 to send and receive parking transaction details. Such details may include indications that a vehicle has been parked in a particular parking space, which the parking transaction server 210 may receive from the sensor device 290 over various types of networks, such as wireless fidelity (WiFi), WiFi Direct, Bluetooth®, etc. As another example, the terminal communication module 256 may communicate with a user device to send and receive parking transaction information. For example, the terminal communication module 256 may send an authentication code to a user device 270 via near field communication (NFC). Other communication techniques and/or networks may be used in other examples.

The terminal communication module 256 may also receive instructions that cause the parking transaction terminal 240 to implement certain functions, in one embodiment. For example, the terminal communication module 256 may receive a message from the parking transaction server 210 that approves a requested parking transaction, such as purchasing parking time, extending parking time, or transferring parking time. Upon receiving the message, the terminal communication module 256 may parse the message, display contents within the message (e.g., the updated parking time remaining, an authentication code, a status message such as approved or denied, etc.). Upon receiving an approval message, for example, the terminal communication module 256 may cause the parking transaction terminal 240 to begin implementing the requested parking transaction. For example, the amount of parking time remaining may increase from a first parking time remaining to a second parking time remaining in response to the parking transaction server 210 sending a message approving a parking time extension by an amount of time indicated in the response message.

The sensor device 290 may detect (e.g., via a detector 294) a vehicle's occupancy of a parking space. For example, the sensor device 290 may detect when a vehicle has entered a parking space and exited a parking space. Examples of the types of detection techniques are described above in association with FIG. 1. A transceiver 292, or a transmitter in some embodiments, may enable the sensor device 290 to transmit information associated with a vehicle's occupancy, the date and time of the occupancy or exit, as well as other information. The sensor device 290 may include a memory 291, such as volatile or non-volatile memory, that may store various information. In one configuration, the memory 291 may store a parking space identifier with which the sensor device 290 may be associated. The parking space identifier may be included along with occupancy information described above to facilitate storage of parking state information for a particular parking space, as will be described in detail below.

The user devices 270 may include a smartphone, a laptop computer, or other device described above that may communicate with the devices in FIG. 2 to facilitate the processes described herein. In one embodiment, a user device 270 may include one or more user applications 276 that may configure a user device to perform such facilitation. For example, the one or more user applications 276 may include, but are not limited to, a browser 278 and an image capture module 280. The browser 278 may receive and display parking transaction information in HTML, XML, or another web-based format from a web server associated with the parking transaction server 210, in one embodiment. Such web-based formats may include embedded server-side code on the parking transaction server 210, such as Java, Java servlets, or Perl, that may implement the described functionality. In other embodiments, a dedicated application, such as a client-server-based application, may provide similar functionality.

The image capture module 280 may provide an interface that enables a user to operate a camera or other image capturing device to capture and store images. Such image capturing devices may be embedded into user devices as described herein. The image capture module 280 may enable capturing of an authentication code from a display associated with the parking transaction terminal 240, in one embodiment. Some embodiments may not involve an image capture module 280 but may include an embedded camera or device that enables a user to capture images, such as the authentication code. An authentication code may be represented as a bar code, a Quick Response (QR) code, or other formats for encoding data.

The user communication module 281 may configure the user device 270 to communicate with other devices shown in FIG. 2 over different types of networks. Such networks may include wireless fidelity (WiFi), WiFi Direct, Bluetooth®, NFC, etc. As an example, the user device 270, e.g., via the user communication module 281, may receive an authentication code or other information from the parking transaction terminal 240, as well as send information to the parking transaction terminal 240 via NFC.

The display 282 may show user interfaces that may request parking transaction content 284 from a user utilizing the user device 270. An example user interface may include text boxes, drop-down selection boxes, radio buttons, other web-based components, or components that may exist in a software development kit (SDK) for creating a dedicated application, according to certain embodiments.

The above configuration in FIG. 2 is not meant to be limiting. At least a portion of the functionality performed by the devices in FIG. 2 may be performed by other devices. For example, in one embodiment, at least a portion of the functionality performed by the parking transaction server 210 may be performed by the parking transaction terminal 240. Numerous other configurations may exist in other embodiments.

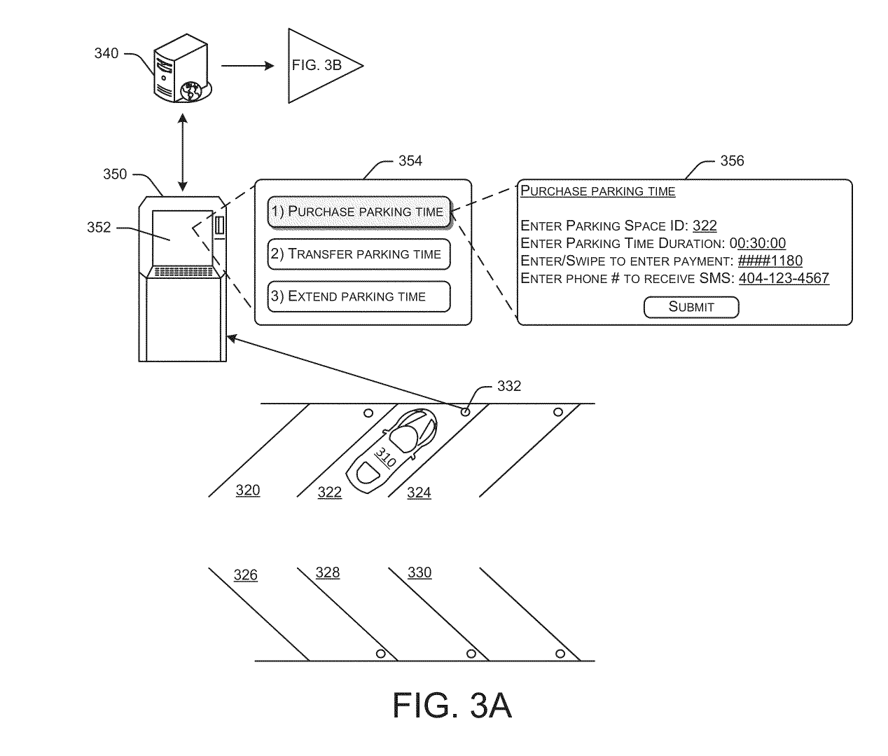

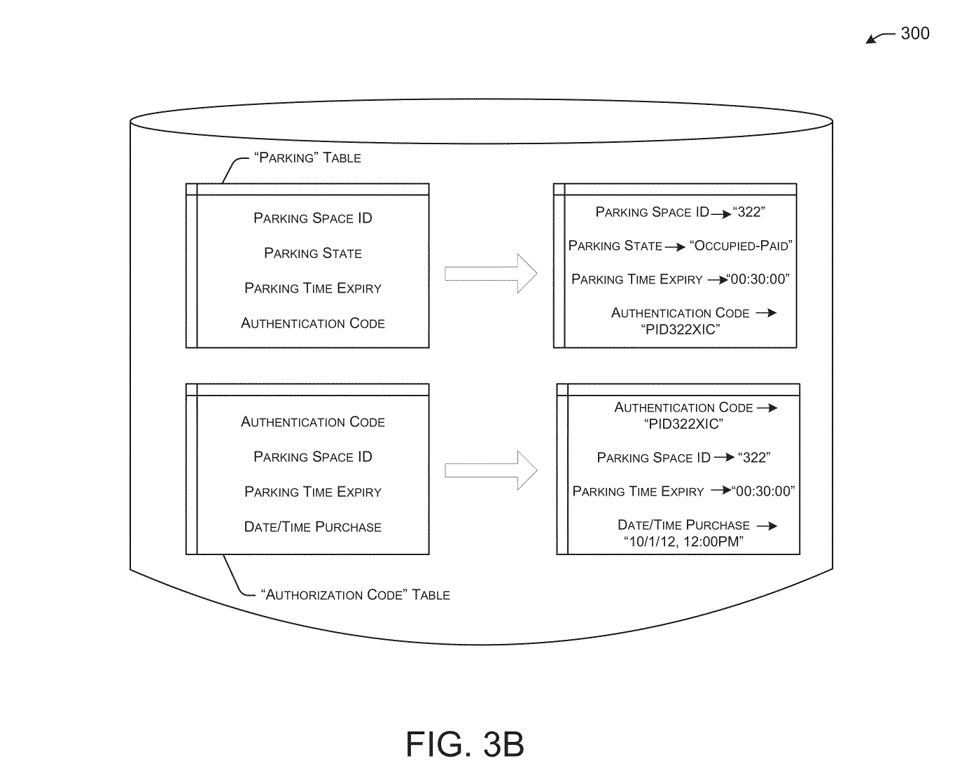

FIG. 3A depicts a schematic diagram of an example parking transaction for which an authentication code may be generated, according to an embodiment of the disclosure. The example parking transaction may include a user purchasing parking time for parking a vehicle in a parking space. For example, a user may park the vehicle 310 in the parking space 322. To purchase time authorizing the vehicle to remain parked in the parking space 322, a user may access a parking transaction terminal 350 to purchase parking time, in one embodiment. A display 352 associated with the parking transaction terminal 350 may present one or more graphical user interfaces (e.g., via the terminal presentation module 254) to guide the user through purchasing parking time. For example, a user interface 354 may prompt a user to select which parking transaction the user desires to perform, for example, purchasing parking time, extending parking time, or transferring parking time.

In association with purchasing parking time, a user may be prompted to specify a parking space identifier (e.g., a unique identifier associated with the parking space, such as “322” in FIG. 3A), a parking time duration (e.g., a time duration for which the vehicle 310 may be authorized to park in the parking space 322), payment information (e.g., credit card, debit card, or other financial information that may be utilized to purchase the parking time), and a phone number or other unique identifier for a smart phone or other device that may allow a user device to receive information, such as an authentication code, for use by a user, as non-limiting examples. Such information may be specified in the user interface 356, as shown in FIG. 3A.

In the present example, a user may specify parking space identifier “322,” a parking time duration of “00:30:00” (thirty minutes), credit card information via a keyboard input, card swipe, or bar code reader associated with the parking transaction terminal 350, and a phone number “404-123-4567” associated with a smart phone. Such information (or parking transaction information) may be sent from the parking transaction terminal 350 to the parking transaction server 340 upon a user selecting a submit option (hence the arrow connecting the two devices in FIG. 3A), in one embodiment.

The parking transaction server 340 may perform various functions upon receiving the parking transaction information. For example, the parking transaction server 340 may generate a unique authentication code associated with the transaction to purchase parking time, as described above. Such an authentication code may be “PID322X1C” for purposes of illustration. In one embodiment, the parking transaction server 340 may send the authentication code to the parking transaction terminal 350, where a user may access the authentication code. For example, a user may print the authentication code from the parking transaction terminal 350, capture the authentication code via a camera or other image capturing device associated with a user device (e.g., the user device 270 in FIG. 2), transfer the code to a user device through NFC, etc. In other embodiments, the parking transaction server 340 may send the authentication code to user device, for example, via the phone number “404-123-4567” or other unique identifier specified by the user at the parking transaction terminal 350, as described above. In one embodiment, an SMS text message including the authentication code may be sent to the phone number.

The parking transaction server 340 may further store the parking transaction information in a database. In one embodiment, such a database may include the database tables shown in FIG. 3B, such as a “parking” table and an “authentication code” table. The “parking” table may include fields to store data associated with a parking space identifier, a parking state, a parking time expiry, and an authentication code, as shown in FIG. 3B. The “authentication code” table may include fields such as an authorization code, a parking space identifier, a parking time expiry, and the date/time of purchase. Fewer or more fields, tables, or databases may exist in other embodiments. The table and field names may also be different. Numerous other differences may also exist in other embodiments.

According to the example shown in FIG. 3A, the parking transaction server 340 may store the parking information in the database tables associated with a database 300, as indicated in FIG. 3B. For example, the parking space identifier field in both the “parking” table and the “authentication code” table may receive a value of “322” associated with the parking space in which the vehicle 310 is parked; the parking state field may receive a value of “Occupied-Unpaid” and may later be updated to reflect “Occupied-Paid” as will be described in greater detail below; the parking time expiry field may receive a value of “00:30:00,” which was the parking duration specified by the user; and the authorization code may receive a value of “PID322X1C,” which may be the unique authentication code generated by the parking transaction server 340. In addition to or as an alternative to database tables, other storage mechanisms or techniques, such as those described above, may be utilized in other embodiments.

In one embodiment, the parking space identifier may be provided to the parking transaction server 340 via the sensor device 332 instead of, or in addition to, a user specifying the parking space identifier at the parking transaction terminal 350, for example. According to this embodiment, indications that a vehicle has entered or exited a parking space detected by the sensor device 332 may be sent to the parking transaction terminal 350 (which may forward the indications to the parking transaction server 340) or directly to the parking transaction server 340. The sensor device 332 may be associated with a particular parking space in the way that an identifier associated with the parking space may be stored in a memory associated with the sensor device 332. In this way, indications or other messages sent from the sensor device 332 may include a parking space identifier with which the sensor device 332 is associated.

In embodiments in which a parking space identifier is received from both a user and a sensor device, the parking space identifier entered by the user may be validated against the parking space identifier received from the sensor device 332. For example, a user may specify the parking space “322” in association with parking the vehicle 310 in the parking space 322. In one embodiment, upon receiving the parking space identifier “322,” the parking transaction server 340 may check the parking state field in the parking transactions database associated with the parking space identifier “322” to determine whether the parking state field contains a value that is indicative of a vehicle being parked in the parking space 322. Such values may include “Occupied-Unpaid” or “Occupied-Paid.” If the parking state contains such a value, then the parking transaction server 340 may determine that the user has entered the correct parking space identifier. If the parking state has not been set to such a value, then the parking transaction server 340 may reject the request to purchase parking time, request that the parking space identifier be reentered by the user, request confirmation from the user that the parking space identifier is correct, etc.

Parking states may be established according to the following example, according to one embodiment. Before the vehicle 310 enters that parking space 322, the parking state may be set to “Vacant” to indicate that a vehicle is not currently occupying the parking space 322. In one embodiment, a sensor device 332 may detect that a vehicle has exited (e.g., no longer occupies) a parking space and may communicate such an indication to the parking transaction terminal 350, which may send the indication to the parking transaction terminal 350. The parking transaction terminal 350 may establish a “Vacant” or other value and store the value in the parking state field of the parking transactions database. Upon the vehicle 310 being parked in the parking space 322, the sensor device 332 may send such an indication to the parking transaction terminal 350, which may send the indication to the parking transaction server 340. The parking transaction server 340 may establish a default value of “Occupied-Unpaid” to indicate that the vehicle 310 currently occupies the parking space 322, and payment for parking the vehicle 310 in the parking space 322 has not yet been received and verified. Upon the parking transaction server 340 receiving payment associated with the vehicle 310 parking in the parking space 322, the parking transaction server 340 may update the parking state to “Occupied-Paid.” Upon the vehicle 310 exiting the parking space 322, the parking state may return to “Vacant” upon the sensor device 332 detecting that the vehicle 310 is no longer in the parking space 322.

In determining the “Occupied-Paid” value, the parking transaction server 340 may perform an additional function to verify or facilitate verification of payment for a parking transaction. In one embodiment, the parking transaction server 340 may communicate with a financial institution to determine whether credit card information, for example, is valid and that sufficient funds exist for purchasing the requested amount of parking time. If a purchase request is validated, the parking transaction server 340 may update the parking state with the “Occupied-Paid” value. The parking transaction server 340 may further send a response message to the parking transaction terminal 350 that may cause the parking transaction terminal 350 to begin tracking parking time associated with the vehicle's 310 occupancy of parking space 322, in one embodiment. The response message may include a status message (e.g., “approved”) and the amount of time that was successfully purchased. The parking transaction terminal 350 may, upon receiving the “approved” message, display the parking time remaining on the display 352 and, as described, begin tracking or decrementing time associated with the vehicle 310 being parked in the parking space 322. If the requested purchase was denied, the response message from the parking transaction server 340 may include a “denied” message, and the parking transaction terminal 350 may not track and decrement time associated with the vehicle 310 being parked in the parking space 322.

The above examples in FIG. 3A are non-limiting. For example, in some embodiments, a user may utilize a user device, such as the user device 270, to purchase parking time. A dedicated application 276 or a browser 278 may provide a user interface that allows the user to interact with the parking transaction server 340 to purchase the parking time. An authentication code generated in association with the purchase may be sent from the parking transaction server 340 to the user device, according to these embodiments. As another example, different values may exist in other examples, such as values for the parking state, authentication code, other database fields, etc. A database may not exist in some embodiments. Data storage may be implemented instead in files, lists, arrays, other data stores, or other storage mechanisms. Also, the vehicle 310 may be parked in any of the parking spaces 320, 322, 324, 326, 328, and 330, in other examples.

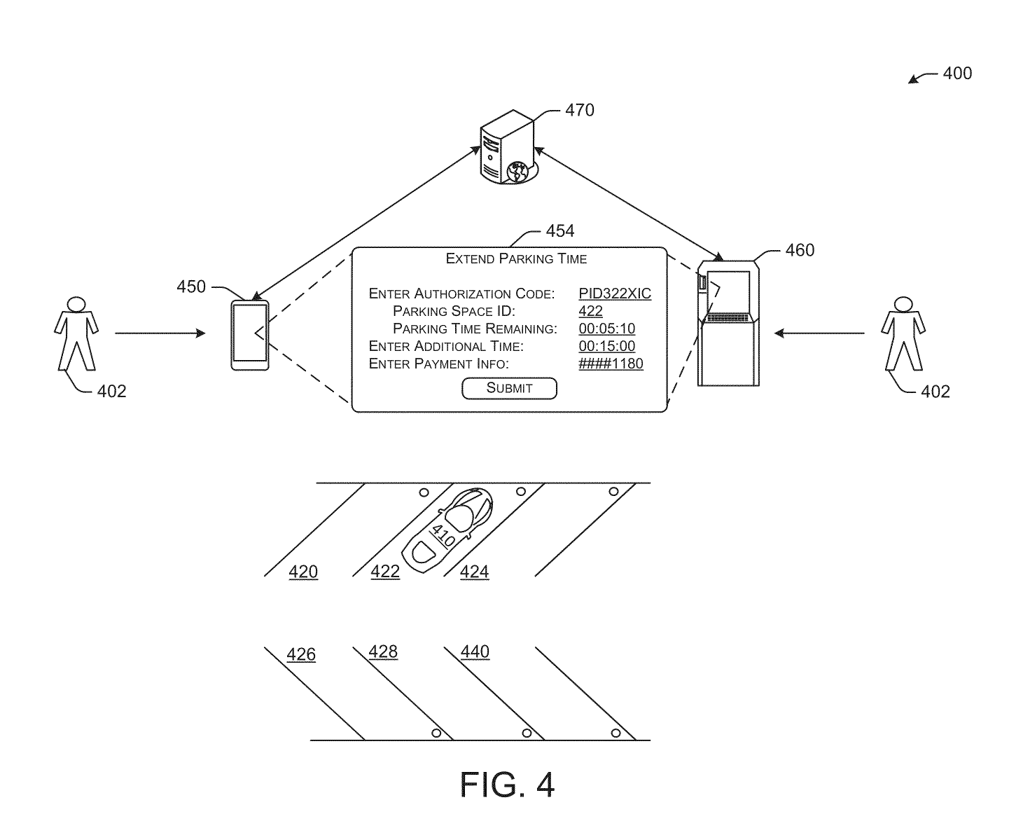

FIG. 4 depicts a schematic diagram of an example system for extending vehicular parking time via a user device, according to an embodiment of the disclosure. In one embodiment, at least the vehicle 410 and the parking space 422 in FIG. 4 may embody the vehicle 310 and the parking space 322 in FIG. 3, respectively. In one embodiment, after the vehicle 410 has been parked in the parking space 422 and parking time has been purchased, a user 402 may utilize the user device 450, such as a smart phone, to extend the amount of time remaining for parking the vehicle 410 in the parking space 422. The user 402 may be located any distance away from the vehicle 410 so long as the user device 450 has access (e.g., network access) to the parking transaction server 470, in one embodiment.

An example user interface 454 may be presented on a display 452 as parking transaction content 284 in FIG. 2, in one embodiment. The parking transaction content 284 may be rendered by the browser 278 or a dedicated user application 276 shown in FIG. 2. As shown, the user interface 454 may prompt the user for an authentication code, additional time by which to extend the current parking time expiry, and payment information to purchase the additional time. In one embodiment, upon receiving the authentication code from the user device 450, the parking transaction server 470 may access the parking table (or other storage mechanism) to identify parking transaction details associated with the authentication code. Such details may include, but are not limited to, the parking space identifier and parking time duration remaining, as shown in FIG. 4. The parking transaction server 470 may send such details to the user device 450, where they may be displayed in the user interface 454.

According to one example, the user 402 may specify the authentication code “PID322X1C” that was generated in association with a parking transaction to purchase time for parking the vehicle 310 in the parking space 322 in FIG. 3, embodied as parking space 422 in FIG. 4. In response, the parking transaction server 470 may access and return the parking space identifier “422” and 00:05:10 (five minutes, ten seconds) stored as parking time expiry. The parking time expiry may represent the time remaining that the vehicle 410 may be authorized to park in the parking space 422. Such a time may have been decremented from the original parking time duration of 00:30:00 (thirty minutes) purchased as described in FIG. 3. In one embodiment, the parking transaction server 470 may periodically update the parking time expiry (e.g., every second or another time interval) to reflect a reduced amount of time associated with parking the vehicle 410 in the parking space 422. In other embodiments, the parking transaction server 470 may receive such information periodically from the parking transaction terminal 460, which may track the amount of parking time remaining. Such updates may be sent every second or another time interval such that the parking transaction server 470 may track the amount of parking time remaining associated with parking a vehicle in a parking space. The parking transaction server 470 may update a database with the information received from the parking transaction terminal 460.

Other techniques may be utilized to track an amount of parking time remaining. In one embodiment, the database 300 may include additional fields to facilitate a determination of the remaining parking time. Such fields may include an “expiration date/time” field, a “paused” field, and a “paused time” field. The field names are for illustration purposes only and are not meant to be limiting. Any name, unique description, or identifier may be used for field names in other examples.

The “expiration date/time” field may store the date and time (e.g., time of day) at which parking may expire, and hence, the authentication code associated with the parking time. The “paused” field may indicate whether a timer associated with an amount of parking time remaining is currently running (e.g., decrementing) or is paused. In one example, the “paused” field may include a Boolean value, such as true or false, where true indicates that the parking time remaining has been paused, and false indicates that the parking time remaining is currently decrementing. Other values that may indicate the current state of the remaining parking time (e.g., decrementing or paused) may exist in other examples. The “paused time” field may indicate that time at which an amount of parking time remaining was paused. Such a time may be associated with the time at which a vehicle exited a parking space, in one embodiment.

The parking transaction server 470 (e.g., via the data management module 232), may use the “expiration date/time” field, the “paused” field, and the “paused time” field, along with the time at which parking time was purchased (e.g., “date/time purchase” field in FIG. 3B), to track an amount of parking time remaining For example, if thirty minutes (00:30:00) of parking time was purchased at 12:00 PM, the “expiration date/time” may be set to 12:30 PM. If a vehicle associated with the purchase exits a parking space at 12:20 PM, then, upon receiving an indication that the vehicle exited the parking space, the parking transaction server 470 may update the “paused time” field to include 12:20 PM and may update the “paused” field to include “true” or another value indicating that the parking time remaining has been paused. According to the present example, the parking transaction server 470 may calculate a parking time remaining of ten minutes (00:10:00).

When the parking transaction server 470 receives a request to continue using the remaining parking time (e.g., via receiving an authentication code associated with the parking transaction), the parking transaction server 470 may update the “paused” field to “false” (or another value that indicates that the parking time remaining is not paused) and may begin decrementing the parking time remaining by updating the “expiration date/time” field with the current time. The parking transaction server 470 may perform such determinations or calculations upon request, periodically (e.g., when the parking transaction terminal 470 receives an indication that a vehicle has exited a parking space), at predetermined time intervals, etc.

The user 402 may enter an amount of additional parking time to be purchased via payment information associated with a credit card or other form of payment, which may also be entered into the user interface 454 as shown. If the payment information is verified, then the additional parking time requested may be added or summed to the parking time expiry field in the parking transaction database (e.g., the “parking” table and/or the “authentication code” table), e.g., via the data management module 232, thereby associating additional time with the user 402 parking the vehicle 410 in the parking space 422. In the present example, the user 402 may specify an additional parking time of 00:15:00 (fifteen minutes) to extend the parking time to 00:20:10 (twenty minutes, ten seconds).

The parking transaction server 470 may respond by sending a message to the user device 450 indicating whether the requested transaction was successful, as well as providing various information, such as the increased parking time expiry value. The parking transaction server 470 may also send a response message to the parking transaction terminal 460 that may cause the parking transaction terminal to adjust its parking time remaining to reflect the extended parking time amount. Such an amount of parking time may be displayed in the display 452. The response message, as described above, may include a status (e.g., approved or denied) and the extended parking time, among other information.

In other embodiments, a parking transaction terminal 460 may be utilized to extend parking time associated with parking a vehicle in a parking space. In one embodiment, the parking transaction terminal 460 may include a user interface that is the same or similar to the user interface 454 for extending parking time.

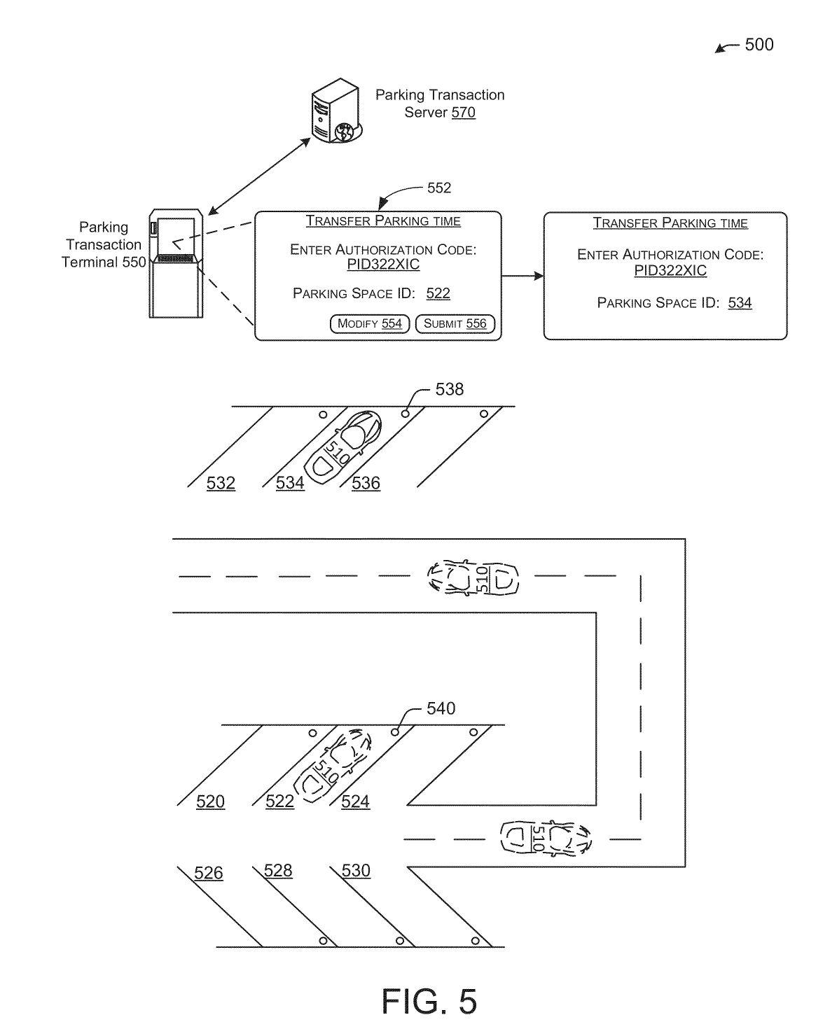

FIG. 5 depicts a schematic diagram of an example system for transferring vehicular parking time between parking spaces, according to an embodiment of the disclosure. In transferring parking time, a user may utilize an authentication code that was used to park a vehicle in one parking space for parking the vehicle in another parking space. Parking time associated with the authentication code may therefore be used for parking a vehicle in multiple parking spaces, for example, a first (or initial) parking space and one or more subsequent (or destination) parking spaces.

In one embodiment, a parking transaction terminal 550 may be utilized by a user to transfer parking time. In one aspect of the embodiment, the parking transaction terminal 550 may provide a user interface 552 with which a user may interact to transfer parking time. As shown, the user interface 552 may prompt the user for an authentication code. Upon receiving the authentication code, the parking transaction server 570 may return parking transaction data associated with the authentication code, such as a parking space identifier and a parking time expiry, as non-limiting examples. The user interface 552 may further include an option that enables a user to specify a new parking space identifier associated with a new parking space in which a vehicle may be parked. As described in the example below, the new parking space identifier may be associated with an existing authentication code to authorize parking a vehicle in a new parking space.

An example of transferring parking time in FIG. 5 may be as follows. A user who parked a vehicle 510 in the parking space 522 may drive the vehicle 510 to a different parking space, such as parking space 534. Phantom lines are shown in FIG. 5 to illustrate the user driving the vehicle 510 from the parking space 522 to the parking space 534. Upon the vehicle exiting the parking space 522, the sensor device 540 may detect such an exit and send a corresponding indication to the parking transaction terminal 550 (which may send the indication to the parking transaction server 570) or the parking transaction server 570. The parking transaction server 570, in response to receiving the indication, may pause or halt (e.g., no longer decrement) the parking time expiry value associated with the authentication code such that the parking time remaining does not continue to decrease while the vehicle 510 is en route to another destination, for example. In one embodiment, the pausing of the parking time expiry value may be accomplished by the parking transaction terminal 550 no longer sending periodic updates of decreases in parking time remaining to the parking transaction server 570. Such actions may preserve parking time associated with an authentication code to enable a user to use the remaining parking time for parking in another parking space.

As shown in FIG. 5, a user may enter authentication code “PID322X1C.” The user may subsequently select a submit option to transmit the authentication code to the parking transaction server 570, where a parking time expiry value of “00:10:00” may be accessed and transmitted to the parking transaction terminal 550. Such a time may reflect the amount of parking time associated with authentication code “PID322X1C” that is remaining for parking. The last parking space identifier associated with the authentication code (e.g., parking space identifier “522”) may also be transmitted to the parking transaction terminal 550.

A user may select a feature, such as the modify button 554, to enter a different parking space identifier in the parking space identifier field in the user interface 552. In the present example, the user may enter the parking space “534” in which the vehicle 510 is currently parked. A user may select the submit button 556 (or similar feature) to transfer the new parking space identifier to the parking transaction server 570. In one embodiment, the parking space identifier may be sent in a message that includes the parking space identifier, the authentication code entered by the user, and other information associated with the transaction to transfer parking time. In one embodiment, the sensor device 538 may communicate a message that includes an indication that the vehicle 510 has parked in the parking space 534.

The parking transaction server 570 may perform various functions upon receiving such information. For example, the parking transaction server 570 may update the parking space identifier field in the parking transactions database to show the new parking space identifier in association with the authentication code entered by the user. The parking transaction server 570 may also send a message, e.g., via the communication module 226, indicating that the requested transfer of parking time has been approved or denied. The transaction may be approved if the authentication code is valid and the parking time expiry associated with the authentication code is not zero, or the transaction may be denied if either of these criteria are not met (e.g., invalid authentication code or zero time remaining in parking time expiry). The parking transaction server 570 may further update the parking transaction database tables (e.g., as shown in FIG. 3B) such that the new parking space identifier (e.g., “534”) is associated with the authentication code (e.g., “PID322X1C”).

The parking transaction server 570 may further send a response message to the parking transaction terminal 550 that may cause the parking transaction terminal to begin tracking or decrementing an amount of parking time associated with the parking space 534. As described, such an amount of parking time may have been previously associated with the vehicle 510 being parked in the parking space 522. The response message sent from the parking transaction server 570 may include a status message (e.g., approved or denied) and the parking time remaining that will serve as remaining parking time for parking in the parking space 534.

The parking transaction server 570 may begin to periodically receive parking time remaining updates from the parking transaction terminal 550 as time passes (e.g., every second or another time interval), which it will use to update the parking time expiry in the parking transactions database, in one embodiment. In another embodiment, the parking transaction server 570, e.g., via the data management module 232, may periodically decrement the time value in the parking time expiry field.

The above example in FIG. 5 is not meant to be limiting. Some examples may involve transferring parking time via a user device, such as the user device 270. In these examples, a browser 278 or a dedicated user application 276 may facilitate the association of an authentication code with multiple parking spaces. As another example, different user interfaces, prompts for information, etc., may exist in other embodiments.

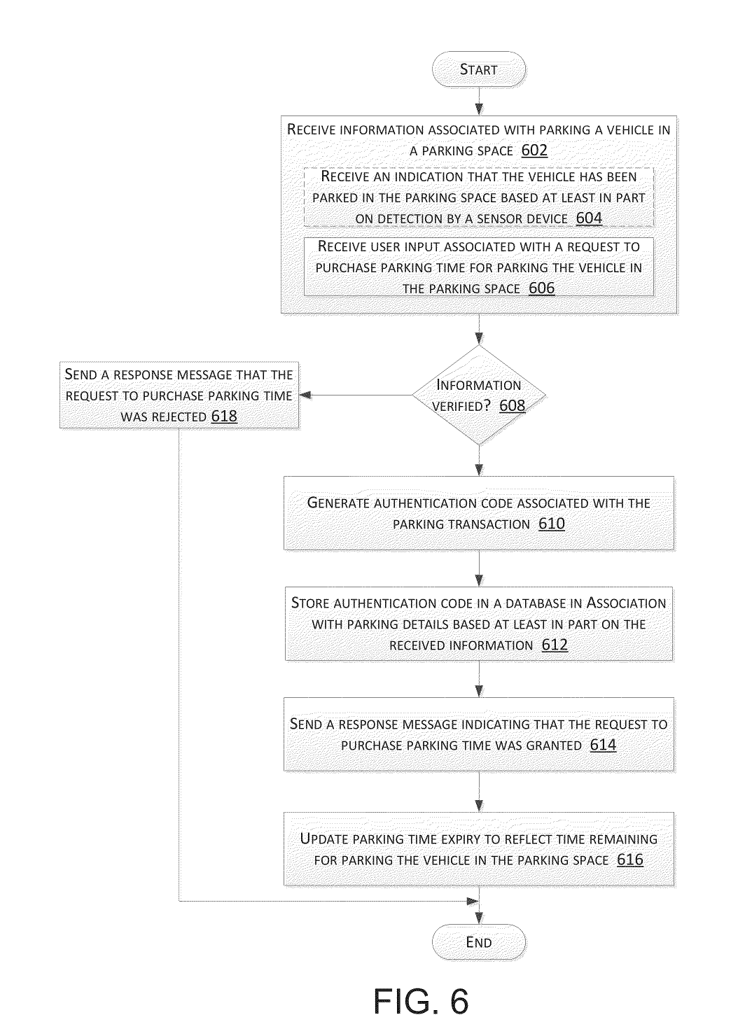

FIG. 6 depicts a flow diagram of an example process for storing parking transaction information associated with purchasing parking time, according to an embodiment of the disclosure. The example process may be implemented by a parking transaction server 210 in FIG. 2, in one embodiment. The example process may begin at block 602, where information associated with parking a vehicle in a parking space may be received. Such information may include an indication that the vehicle has been parked in the parking space, at block 604. The indication may be received from a sensor device, e.g., the sensor device 290, in one embodiment. Additional or alternative information may include user input associated with a request to purchase parking time for parking the vehicle in the parking space, which may be received at block 606. The information may be received from a parking transaction terminal, e.g., the parking transaction terminal 240, and may include a parking space identifier, a parking time duration for which the vehicle may be authorized to park in the parking space, information for purchasing the parking time duration, and a unique identifier (e.g., a phone number), as non-limiting examples.

The received information may be validated, at block 608. Example validations may include verifying that payment information (e.g., credit card number) is valid and that sufficient funds exist in an account associated with the payment information. Also, the parking space identifier may be validated to ensure that it exists. For example, the received parking space identifier may be checked against a database of valid parking space identifiers to verify the parking space identifier. Further, the parking space identifier entered by a user may be validated against occupancy information received from the sensor device. For example, an “Occupied-Unpaid” parking state based on an indication received from the sensor device may be required to exist for a parking space identifier entered by a user, in one embodiment. Numerous other validations may be performed in other embodiments.

If the received information is not verified, at block 608, then a message indicating a rejection of the request to purchase parking time may be sent to a device associated with the request (e.g., the parking transaction terminal 240 or a user device 270 via the unique identifier).

If the received information is successfully verified, then an authentication code associated with the parking transaction may be generated, at block 610. Such an authentication code may be utilized to extend parking time and transfer parking time as described herein, among other functions. In one embodiment, the authentication code may be stored in a database in association with the parking transaction information based at least in part on the received information, at block 612. For example, a table (e.g., the “parking” table) may be updated to store the parking space identifier, the parking state (e.g., determined by the parking transaction server to be “Occupied-Paid” after payment has been received for the parking space), a parking time expiry, and the generated authentication code. An “authentication code” table may store similar information, as described above. Various other information may be stored in other embodiments.

At block 614, a response message may be sent to one or more devices, such as a parking transaction terminal 240 or a user device 270. In one embodiment, the response message may include a confirmation that the parking time was successfully purchased, the authentication code that was generated in association with the purchase, a receipt of the purchase, or a message indicating that the purchase of the parking space was unsuccessful, in one embodiment. In one embodiment, the response message may cause the parking transaction terminal 240 to begin tracking or decrementing parking time associated with a vehicle occupying a parking space. A user may capture the information sent in the response message via printing at the parking transaction terminal, via image capture using a user device, via near field communication (NFC) between the user device and the parking transaction terminal, or various other techniques.

At block 616, the parking time expiry (or similar information) may be periodically updated or updated upon the occurrence of certain events, such as the parking transaction server receiving parking transaction information. The update may be performed by the parking transaction server 210, e.g., via the data management module 232, to reflect a decrease in time parking for parking the vehicle in the parking space. In this way, the parking transaction server 210 may know when the parking time remaining has expired and may send a corresponding message to the parking transaction terminal 240, in one embodiment. In other embodiments, the parking transaction terminal 240 in FIG. 2 may communicate the parking time remaining to the parking transaction server 210, which may update the database based on such parking time remaining.

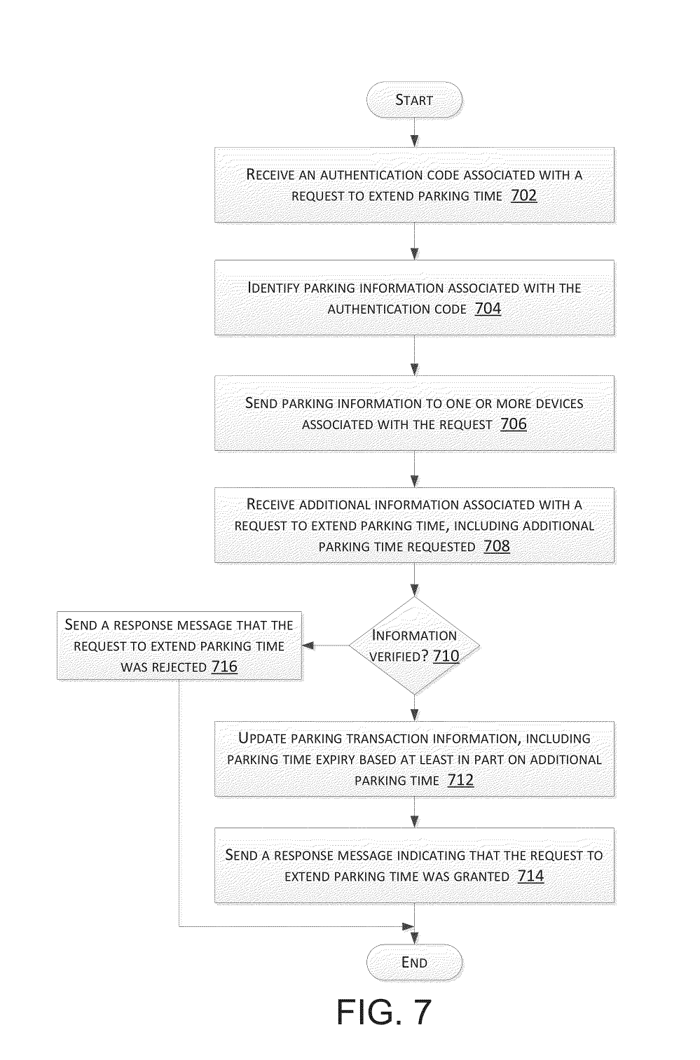

FIG. 7 depicts a flow diagram of an example process for extending parking time associated with parking a vehicle in a parking space, according to an embodiment of the disclosure. The example process may be implemented by the parking transaction server 210 in FIG. 2, in one embodiment. In one aspect of the embodiment, a user may utilize a user device 270 to interact with the parking transaction server 210. The example process may begin at block 702, where an authentication code associated with a request to extend parking time may be received. The authentication code may have been generated in association with purchasing time for parking a vehicle in a parking space, for example, the same parking space for which a time extension is requested.

At block 704, parking transaction information associated with the authentication code may be identified and sent to one or more devices associated with the time extension request (e.g., a user device 270 or a parking transaction terminal 240 in FIG. 2), at block 706.

At block 708, additional information associated with a request to extend parking time, such as, but not limited to, an additional parking time by which to extend the parking time, may be received by the parking transaction server 210. Payment information for purchasing the additional time may also be received.

A determination of whether the received information is valid may be performed at block 710. For example, the specified authentication code and the payment information may be verified to determine whether each is valid. As another example, a determination may be made regarding whether the parking time associated with the authentication code remains (e.g., has not expired). If time associated with the authentication code does not remain, then the parking transaction server 210 may reject a request to extend parking time. Numerous other verifications may be performed in other examples. If the verification is not successful, then a message rejecting the request to extend parking time may be sent to one or more devices associated with the request (e.g., the user device 270), at block 716.

If the verification is successful, then parking transaction information associated with the authentication code may be updated, at block 712. For example, the additional parking time requested by a user may be summed with the parking time expiry to arrive at an adjusted parking time expiry. At block 714, a response message may be sent to the user device indicating that the parking time extension was approved. The response message may include a status (e.g., approved or denied), an amount by which the remaining parking time was extended, the combined new parking time remaining, etc. A response message may also be sent to a parking transaction terminal associated with the parking space (e.g., a parking transaction terminal 240) that may cause the parking transaction terminal to begin decrementing the parking time remaining.

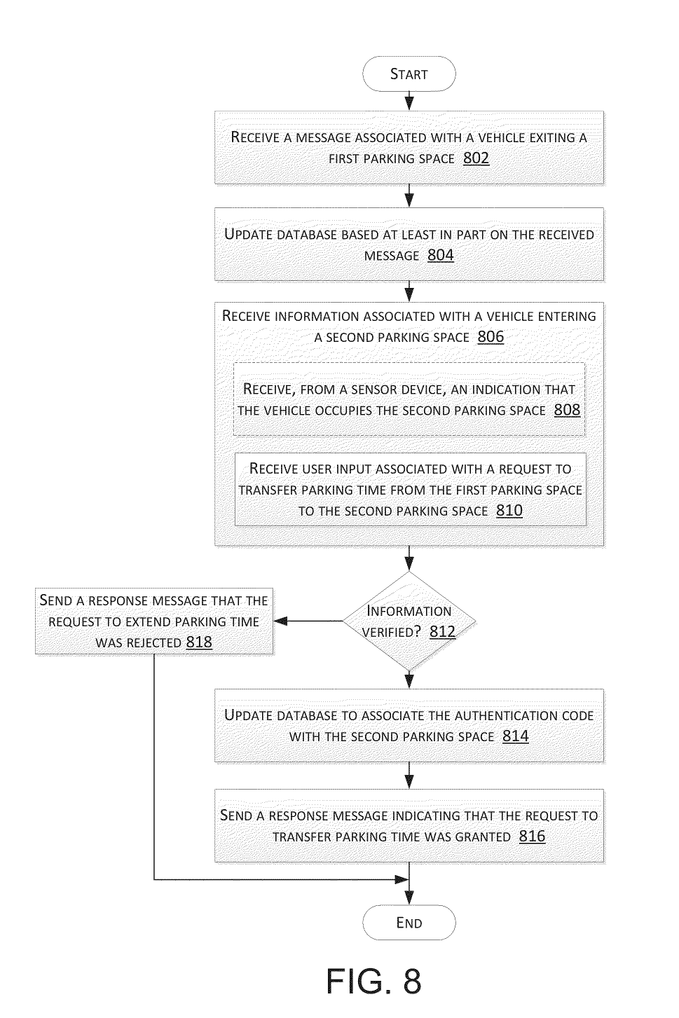

FIG. 8 depicts a flow diagram of an example process 800 for transferring parking time between parking spaces, according to an embodiment of the disclosure. The example process may be performed by the parking transaction server 210 in FIG. 2, in one embodiment. The process may begin at block 802, where a message associated with a vehicle exiting a parking space may be received. In one embodiment, such information may include an indication from a sensor device (e.g., the sensor device 290 in FIG. 2) that the vehicle has exited the parking space, and a parking space identifier associated with the parking space from which the vehicle exited. The parking space identifier may be associated with the sensor device 290, in one embodiment.

At block 804, parking transaction details may be updated based at least in part on the received information. For example, a parking state associated with the parking space identifier may be updated to include a “Vacant” status or other status indicating that a vehicle no longer occupies that parking space. Additionally, the parking time expiry associated with the parking space identifier (and the corresponding authentication code) may be halted such that the parking time remaining does not continue to decrease.

At block 806, information associated with a vehicle entering a subsequent parking space may be received. According to one example, an indication that a vehicle has entered the subsequent parking space may be received based on detection of such entry by a sensor device, such as a sensor device 290 associated with the subsequent parking space, at block 808. In some embodiments, such an indication may not be received from the sensor device. At block 810, user input associated with a request to transfer parking time from a previous parking space (e.g., the parking space which the vehicle exited) and the subsequent parking space (e.g., the parking space in which the vehicle is currently parked) may be received. Such input may include an authentication code and a parking space identifier associated with the subsequent parking space.

The received information may be verified, at block 812. For example, the authentication code may be verified to ensure that it exists and, for example, has not expired. As another example, the inputted parking space identifier may be verified against a database of valid parking space identifiers, for example, to ensure that it exists. Other verifications may be performed in other examples. If the information is not successfully verified at block 812, then a message that the request to transfer parking time was rejected may be sent to one or more devices associated with the request (e.g., a parking transaction terminal 240 or a user device 270), at block 818.

If the information is successfully verified, then a database including parking transaction details may be updated such that the authentication code specified by the user is associated with the subsequent parking space identifier, at block 814. At block 816, a response message indicating that the request to transfer parking time was successful may be sent to the parking transaction terminal that may cause the parking transaction terminal to begin tracking (e.g., decrementing) parking time remaining associated with parking the vehicle in the subsequent parking space.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method comprising:
receiving, at a server device comprising one or more computing devices, a request to extend a parking duration associated with parking a vehicle in a parking space, wherein the request comprises an authentication code and an amount of time by which to extend the parking duration;
identifying, by the server device, an amount of parking time remaining based at least in part on the authentication code;
updating, by the server device, the parking duration based at least in part on the amount of parking time remaining and the amount of time by which to extend the parking duration; and
sending, by the server device, a response message comprising the updated parking duration to a parking transaction terminal, the response message causing a parking transaction terminal to authorize parking in the parking space for the updated parking duration.

2. The method of claim 1, wherein the request is received from a user device, the method further comprising sending the response message to the user device.

3. The method of claim 1, wherein the authentication code was generated in association with a request to purchase the parking duration.

4. The method of claim 1, further comprising:
receiving, at the server device, payment information for purchasing the amount of time by which to extend the parking duration; and
verifying, by the server device, the payment information;
wherein the response message is sent when the verification is successful.

5. The method of claim 1, further comprising verifying, by the server device, that the parking duration has not expired, wherein the response message is sent when the parking duration has not expired.

6. The method of claim 1, further comprising:
identifying, by the server device, a parking space identifier associated with the authentication code; and
sending the parking space identifier and the amount of parking time remaining to the user device.

7. A system comprising:
a parking transaction terminal;
a sensor device communicatively coupled to the parking transaction terminal;
at least one memory that stores computer-executable instructions; and
at least one processor configured to access the at least one memory, wherein the at least one processor is configured to execute the computer-executable instructions to:
receive an indication that a vehicle has exited a first parking space, wherein the indication comprises a first parking space identifier associated with the first parking space, the indication based at least in part on detection by the sensor device;
identify a parking time expiry associated with the first parking space identifier;
receive a request to transfer parking time associated with the first parking space identifier to a second parking space identifier, wherein the request comprises an authentication code associated with the first parking space identifier and the second parking space identifier;
update a parking space identifier associated with the authentication code with the second parking space identifier; and
send a response message to the parking transaction terminal, the response message causing the parking transaction terminal to authorize parking the vehicle in a second parking space associated with the second parking space identifier for an amount of time equivalent to the parking time expiry.

8. The system of claim 7, wherein the authentication code was generated in association with a request to purchase the parking duration.

9. The system of claim 7, the at least one processor further configured to, in response to receiving the indication, update a parking time expiry associated with the first parking space identifier, wherein updating the parking time expiry pauses an amount of parking time remaining associated with the authentication code.

10. The system of claim 7, wherein the indication comprises a first indication and the sensor device comprises a first sensor device, wherein the at least one processor is further configured to receive a second indication that the vehicle has entered a destination parking space having a destination parking space identifier, the second indication based at least in part on detection of the occupancy by the second sensor device.

11. The system of claim 10, the at least one processor further configured to determine that the second parking space identifier matches the destination parking space identifier.

12. The system of claim 7, the at least one processor further configured to:
receive periodic updates associated with an amount of parking time remaining for parking the vehicle in the second parking space; and
update the parking time expiry based at least in part on the amount of parking time remaining.

13. The system of claim 7, wherein the first indication is received from the parking transaction terminal.

14. The system of claim 7, wherein the response message comprises the parking time expiry.

15. One or more computer-readable media storing computer-executable instructions that, when executed by at least one processor, configure the at least one processor to perform operations comprising:
receiving, from a sensor device, an indication that a vehicle occupies a parking space;
sending the indication, a parking transaction request, and an authentication code associated with the parking transaction request to a server device;
receiving, from the server device, a parking time expiry associated with the parking transaction request; and
displaying the parking time expiry.

16. The one or more computer-readable media of claim 15, the at least one processor further configured to perform the operations comprising:
receiving a response to the parking transaction request; and
in response to receiving the response, decrementing the parking time expiry; and
sending, to the server device, the decremented parking time expiry.

17. The one or more computer-readable media of claim 15, wherein the parking transaction request is a request to transfer parking time associated with the authentication code from a first parking space identifier to a second parking space identifier.

18. The one or more computer-readable media of claim 15, wherein the parking transaction request is a request to extend parking time for parking the vehicle in the parking space.

19. The one or more computer-readable media of claim 15, the at least one processor further configured to perform the operation comprising sending the authentication code to a user device.

20. The one or more computer-readable media of claim 15, wherein the parking space comprises a first parking space, wherein the authentication code was generated in association with a request to purchase time associated with parking the vehicle in a second parking space.

21. The one or more computer-readable media of claim 15, wherein the decrementing and the sending are performed periodically.
